(19) United States
(12) Patent Application Publication
(10) Pub. No.: US 2026/0175676 A1
(43) Pub. Date: Jun. 25, 2026

(54) FILLER NECK INTEGRATED WITH A CORRUGATED PIPE AND A METHOD OF MANUFACTURING THE SAME

(71) Applicants: HYUNDAI MOTOR COMPANY, Seoul (KR); KIA CORPORATION, Seoul (KR)

(72) Inventors: Chang Han Kim, Hwaseong-si (KR); Chang Jun Park, Hwaseong-si (KR); Jae Hwa Park, Hwaseong-si (KR)

(73) Assignees: HYUNDAI MOTOR COMPANY, Seoul (KR); KIA CORPORATION, Seoul (KR)

(21) Appl. No.: 19/263,202

(22) Filed: Jul. 8, 2025

(30) Foreign Application Priority Data
Dec. 19, 2024 (KR) 10-2024-0190668

(51) Int. Cl. B60K 15/04; B29C 49/00; B29C 49/06; B29K 23/00; B29K 77/00; B29K 509/00; B29L 23/18

(52) U.S. Cl. CPC B60K 15/04; B29C 49/0005; B29C 49/06; B29K 2023/08; B29K 2077/00; B29K 2509/00; B29L 2023/183; B60K 2015/0464; B60K 2015/047

(57) ABSTRACT

A filler neck integrated with a corrugated pipe part and a method of manufacturing the same are provided. The filler neck includes a filler pipe configured to be connected to a fuel tank, wherein the filler pipe has an end portion including the corrugated pipe, the end portion being configured to be connected to the fuel tank. In a cross-sectional shape of the corrugated pipe part, a thickness of an upper portion of the corrugated pipe part in a cross section is larger than a thickness of each of a left portion and a right portion of the corrugated pipe part in the cross section.

### CROSS-REFERENCE TO RELATED APPLICATION

This application claims, under 35 U.S.C. § 119(a), the benefit of and priority to Korean Patent Application No. 10-2024-0190668, filed on Dec. 19, 2024, the entire contents of which are incorporated herein by reference.

### BACKGROUND

### Technical Field

The present disclosure relates to a filler neck having a corrugated pipe part integrated with the end of a filler pipe connected to a fuel tank, and a method of manufacturing the same.

### Background

A vehicle includes a fuel tank provided therein and configured to store fuel required for engine combustion, and a filler neck configured for fuel to be injected therethrough connected to a filler hose connected to the fuel tank.

FIG. 1 is a perspective view showing a state in which a conventional filler neck 2 and a filler hose 4 are connected to a fuel tank 1. One end of the filler hose 4 is connected to an inlet 1a of the fuel tank 1, and the other end of the filler hose 4 is connected to a filler pipe 3 of the conventional filler neck 2.

When a driver inserts a fuel gun (not shown) into a fuel inlet 2a of the conventional filler neck 2 and then injects fuel into the fuel inlet 2a, the fuel injected through the fuel gun may be supplied to the fuel tank 1 through the filler pipe 3 and the filler hose 4.

The filler pipe 3 of the conventional filler neck 2 is made of hard plastic (resin). In the related art, to connect the conventional filler neck 2 to the fuel tank 1, the soft filler hose 4 is used to connect the hard filler pipe 3 to the inlet 1a of the fuel tank 1. In other words, when the conventional filler neck 2 is connected to the fuel tank 1, the flexible filler hose 4 is used as a portion connected to the fuel tank 1 to provide ease of assembly.

It is known that a conventional filler hose 4 includes a layer of resin such as fluorine resin that is laminated inside a rubber layer such as nitrile-butadiene rubber (NBR) or epichlorohydrin rubber (ECO). However, this filler hose 4 has a drawback in that evaporation gas (i.e., gas vapor) easily penetrates the filler hose 4.

In addition, the filler hose 4 is used to facilitate assembly, but conversely, when the conventional filler neck 2 is assembled with the fuel tank 1, the filler hose 4 is used to connect the filler pipe 3 of the conventional filler neck 2 to the fuel tank 1, resulting in inconvenience and inefficiency in terms of assembly.

Furthermore, as shown in FIG. 2, since both ends of the filler hose 4 are respectively coupled to and assembled with the inlet 1a of the fuel tank 1 and the end of the filler pipe 3 by using respective coupling members, such as clamps 5, this coupling causing various problems such as an increase in cost, an increase in the number of components, and an increase in the number of assembly procedures.

Additionally, cracks may frequently occur in the conventional filler hose 4 due to deterioration in durability. In this case, cracks may occur when concentrated stress is applied to a clamp coupling portion or a coupling portion between the filler hose 4 and a component adjacent to the filler hose 4.

In addition, the conventional filler hose 4 made of rubber and resin has a disadvantage in terms of fuel resistance. Accordingly, durability of the conventional filler hose 4 may deteriorate due to fuel remaining inside the filler hose 4, and cracks may occur in the filler hose 4.

The above information disclosed in this Background section is only for enhancement of understanding of the background of the disclosure, and therefore it may contain information that does not form the prior art that is already known in this country to those having ordinary skill in the art.

### SUMMARY OF THE DISCLOSURE

The present disclosure has been made in an effort to solve the above-described problems associated with the prior art, and it is an object of the present disclosure to provide a filler neck and a method of manufacturing the same that are capable of suppressing deterioration in assembly performance and increase durability of the filler neck. Due to the use of a separate filler hose in the prior art, there is an increase in cost, an increase in the number of components, and an increase in the number of assembly procedures due to the use of coupling members each adapted to couple the filler hose to the other component. The present disclosure solves these problems and solves a problem related to evaporation gas (i.e., gas vapor) penetrating the filler hose.

The objects of the present disclosure are not limited to the above-mentioned objects, and other technical objects not mentioned herein should be clearly understood by those having ordinary skill in the art to which the present disclosure pertains from the detailed description of the embodiments.

In one aspect, the present disclosure provides a filler neck integrated with a corrugated pipe part, the filler neck including a filler pipe configured to be connected to a fuel tank, wherein the filler pipe has an end portion including the corrugated pipe part, the end portion being configured to be connected to the fuel tank, and in a cross-sectional shape of the corrugated pipe part, a thickness of an upper portion in a cross section of the corrugated pipe part is larger than a thickness of each of a left portion and a right portion in the cross section of the corrugated pipe part.

In an embodiment, the cross-sectional shape of the corrugated pipe part may be an ellipse having a minor axis in an upward-and-downward direction of the corrugated pipe part and a major axis in a left-and-right direction of the corrugated pipe part.

In another embodiment, in the cross-sectional shape of the corrugated pipe part, a distance from a central portion of the corrugated pipe part to the upper portion of the corrugated pipe part may be smaller than a distance from the central portion of the corrugated pipe part to each of the left portion and the right portion of the corrugated pipe part.

In another embodiment, the filler pipe having an end portion including the corrugated pipe part may be molded by a suction blow molding process of injecting a molding material into a cavity through a first side of a closed mold while suctioning the molding material injected into the cavity through a second side of the closed mold, allowing the molding material to move along the cavity, and blowing air into the molding material moving along the cavity, causing the molding material expanded by the air to adhere to an inner surface of the cavity, and thereby molding a pipe shape.

In another aspect, the present disclosure provides a method of manufacturing a filler neck integrated with a corrugated pipe part, the method including molding a filler pipe having an end portion including the corrugated pipe part, where the end portion is connected to a fuel tank, and where, in a cross-sectional shape of the corrugated pipe part, a thickness of an upper portion in a cross section of the corrugated pipe part is formed to be larger than a thickness of each of a left portion and a right portion in the cross section of the corrugated pipe part.

In an embodiment, the cross-sectional shape of the corrugated pipe part may be formed to be an ellipse having a minor axis in an upward-and-downward direction of the corrugated pipe part and a major axis in a left-and-right direction of the corrugated pipe part.

In another embodiment, the cross-sectional shape of the corrugated pipe part may be formed such that a distance from a central portion of the corrugated pipe part to the upper portion of the corrugated pipe part is smaller than a distance from the central portion of the corrugated pipe part to each of the left and right portions of the corrugated pipe part.

In another embodiment, the molding the filler pipe having an end portion including the corrugated pipe part may include a suction blow molding process to mold a pipe shape, the molding process including injecting a molding material into a cavity of a closed mold through a first side of the closed mold, suctioning the molding material injected into the cavity through a second side of the closed mold, allowing the molding material to move along the cavity, blowing air into the molding material moving along the cavity, and causing the molding material expanded by the air to adhere to an inner surface of the cavity to form the pipe shape.

In another embodiment, the cavity of the closed mold may have an end portion including a molding space, the molding space being configured to mold the corrugated pipe part of the filler pipe.

In another embodiment, the filler pipe may be manufactured using a resin composition containing polyamide PA6, PAMXD6, ethylene-octene copolymer (EOC), and nanoclay.

Other aspects and embodiments of the disclosure are discussed below.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed below.

### BRIEF DESCRIPTION OF THE DRAWINGS

The above and other features of the present disclosure are described below in detail with reference to certain embodiments thereof illustrated in the accompanying drawings which are given hereinbelow by way of illustration only, and thus are not limitative of the present disclosure.

FIG. 1 is a perspective view showing a state in which a filler hose and a filler neck of the related art are connected to a fuel tank.

FIG. 2 is a perspective view showing an assembly method of the filler hose of the related art.

FIG. 3 is a perspective view of a filler neck integrated with a corrugated pipe and a fuel tank according to an embodiment of the present disclosure.

FIG. 4 is an enlarged perspective view of a corrugated pipe part of the filler neck according to an embodiment of the present disclosure.

FIGS. 5 and 6 are views each showing a problem of a conventional corrugated pipe.

FIG. 7 is a perspective view of a main component such as a filler pipe of the filler neck according to an embodiment of the present disclosure.

FIG. 8 is a cross-sectional perspective view of the shape of the corrugated pipe part of the filler neck according to an embodiment of the present disclosure.

FIG. 9 is a view showing a process of molding the filler pipe integrated with the corrugated pipe in the filler neck according to an embodiment of the present disclosure.

FIG. 10 is a view showing a mold for blow molding of the filler pipe integrated with the corrugated pipe in the filler neck according to an embodiment of the present disclosure.

FIG. 11 is a view of a comparative example to describe a problem in extrusion molding, showing a straight filler pipe manufactured through extrusion molding.

FIG. 12 is a view showing how gas is blocked in the filler pipe of the filler neck according to an embodiment of the present disclosure.

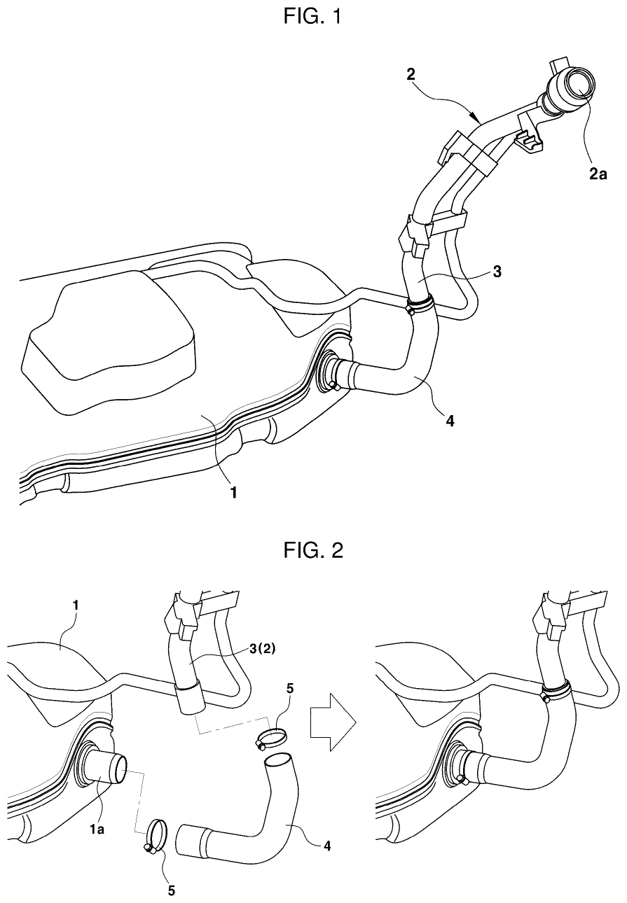

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference is made in detail to various embodiments of the present disclosure, examples of which are illustrated in the accompanying drawings and described below. Specific structural or functional descriptions given in connection with the embodiments of the present disclosure are merely illustrative for the purpose of describing embodiments according to the concept of the present disclosure, and the embodiments according to the concept of the present disclosure may be implemented in various forms. Further, it is understood that the present description is not intended to limit the disclosure to the embodiments described herein. On the contrary, the disclosure is intended to cover not only the disclosed embodiments, but also various alternatives, modifications, equivalents, and other embodiments, which may be included within the spirit and scope of the disclosure as defined by the appended claims.

In the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, i.e., “between” and “directly between” or “adjacent to” and “directly adjacent to”, should be interpreted in the same manner.

The same reference numerals represent the same components throughout the specification. Additionally, the terms in the specification are used merely to describe embodiments and are not intended to limit the present disclosure. In this specification, an expression in a singular form also includes a plural form, unless clearly specified otherwise in context. As used herein, expressions such as “comprise” and/or “comprising” do not exclude the presence or addition of one or more components, steps, operations, and/or elements other than those described.

When a component, device, element, or the like of the present disclosure is described as having a purpose or performing an operation, function, or the like, the component, device, or element should be considered herein as being “configured to” meet that purpose or to perform that operation or function.

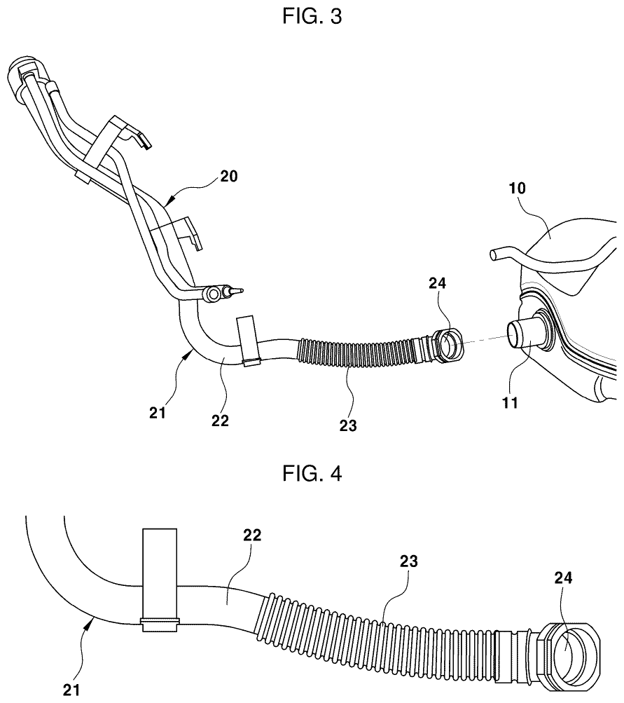

FIG. 3 is a perspective view of a filler neck integrated with a corrugated pipe (i.e., having a corrugated pipe part) and a fuel tank according to an embodiment of the present disclosure. FIG. 4 is an enlarged perspective view of a corrugated pipe part of the filler neck according to an embodiment of the present disclosure.

As shown in the drawings, the present disclosure removes the conventional filler hose separately manufactured and configured to connect an inlet 11 of a fuel tank 10 to a filler pipe 21 of a filler neck 20.

In the present disclosure, instead of the conventional filler hose, a corrugated pipe part 23 is integrated with the end of the filler pipe 21 of the filler neck 20 (i.e., the filler pipe 21 has an end portion including the corrugated pipe part 23), and the corrugated pipe part 23 is connected to the inlet 11 of the fuel tank 10.

Referring to FIG. 3, the corrugated pipe part 23 is integrated with the end of the filler pipe 21 in the filler neck 20 (i.e., the filler pipe 21 of the filler neck 20 has an end portion including the corrugated pipe part 23). As shown in the drawings, the corrugated pipe part 23 may be a part of the filler pipe 21, i.e., a part formed to integrally extend from the filler pipe 21. Further, the corrugated pipe part 23 is a part configured to connect the filler pipe 21 to the inlet 11 of the fuel tank 10.

In an embodiment of the present disclosure, the corrugated pipe part 23 may be formed to have the minimum length allowing the filler pipe 21 of the filler neck 20 to be assembled with the inlet 11 of the fuel tank 10. In other words, the length of the corrugated pipe part 23 at the end of the filler pipe 21 is set to the minimum length required for assembly between the filler pipe 21 and the fuel tank 10.

In an embodiment of the present disclosure, the corrugated pipe part 23 is a part that is flexible when the filler pipe 21 of the filler neck 20 is connected to the fuel tank 10 for assembly therebetween. Further, the corrugated pipe part 23 has a shape capable of being easily deformed so as to be easily connected to the inlet 11 of the fuel tank 10.

In FIGS. 3 and 4, reference numeral “24” indicates a quick connector. The end of the corrugated pipe part 23 is a connection part connected to the inlet 11 of the fuel tank 10, and the quick connector 24 may be installed at the end of the corrugated pipe part 23.

In the present disclosure, as described above, assembly performance may be improved by forming the end of the filler pipe 21 assembled with the fuel tank 10 into a corrugated pipe, such as the corrugated pipe part 23. However, in the conventional corrugated pipe, cracks may occur due to the shape or thickness of the pipe. Further, since the conventional corrugated pipe has a structure in which foreign substances are easily accumulated in a space (a valley portion) formed between peak portions of the corrugated pipe, chemical cracks may be formed in the pipe due to the foreign substances.

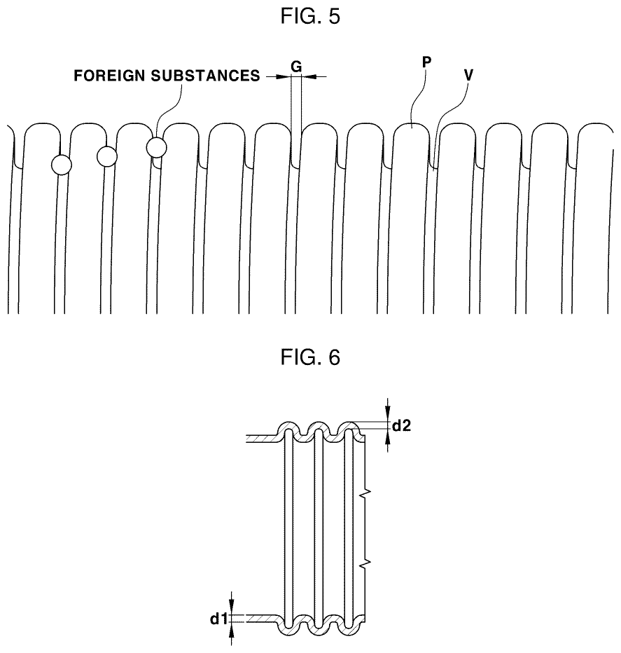

FIGS. 5 and 6 are views each showing a problem of a conventional corrugated pipe. As shown in the drawings, since a conventional corrugated pipe has a gap G formed between peak portions P, foreign substances are readily trapped in a valley portion V that is the gap between the peak portions P. In particular, since the gap G between the peak portions P is small, the foreign substances trapped in the valley portion V may continuously be accumulated in the valley portion and may be fixedly deposited therein.

Particularly, if chemical substances such as calcium chloride (CaCl₂), which is widely used as a deicing agent in winter, are accumulated in the gaps between the peak portions of the corrugated pipe, chemical cracks in the corrugated pipe may occur.

In addition, the conventional corrugated pipe is manufactured using extrusion molding. When the conventional corrugated pipe is formed to be integrated with a regular pipe, i.e., a pipe having a predetermined inner and outer diameter, a molded corrugated pipe part (a thickness: d2) becomes thinner than a regular pipe part (a thickness: d1) (d1>d2). Accordingly, durability of the corrugated pipe part may be insufficient, and cracks may easily occur in the corrugated pipe part.

Therefore, in the present disclosure, while the corrugated pipe part 23 is integrated with the filler pipe 21 of the filler neck 20, the shape, manufacturing method, and material of the corrugated pipe part 23 are improved to prevent the above-described problems in the corrugated pipe part 23 integrated with the filler neck 20.

According to the filler neck 20 integrated with the corrugated pipe part 23, since the conventional filler hose is not used, assembly performance and durability of the filler neck 20 may be improved as compared with a case in which the filler hose is used.

In addition, according to the present disclosure, since coupling members configured to respectively couple both ends of the conventional filler hose to other components are removed, it is possible to reduce manufacturing costs, the number of components, and the number of assembly procedures. Furthermore, it is possible to solve a problem related to evaporation gas penetrating the filler hose.

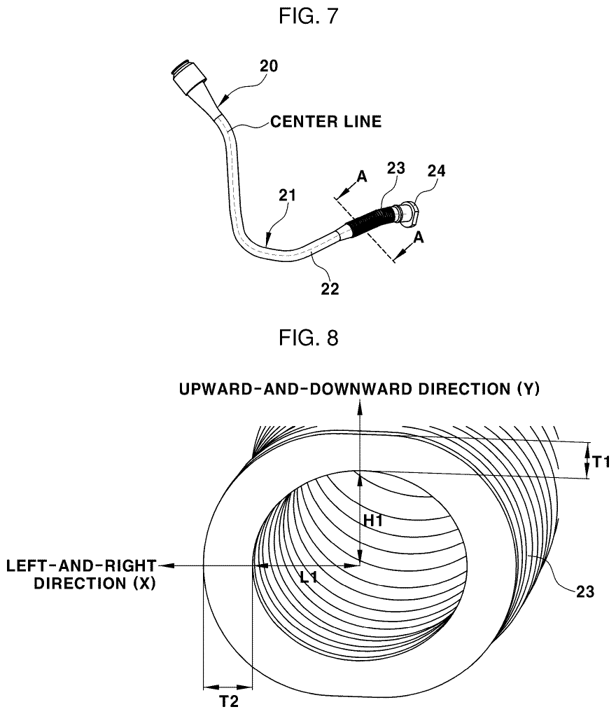

FIG. 7 is a perspective view of the main components such as the filler pipe in the filler neck according to an embodiment of the present disclosure. FIG. 8 is a cross-sectional perspective view showing the shape of the corrugated pipe part in the filler neck according to an embodiment of the present disclosure.

As described above, in the present disclosure, instead of using the conventional filler hose, the corrugated pipe part 23 is integrated with the end of the filler pipe 21 of the filler neck 20 (i.e., the filler pipe 21 of the filler neck 20 has an end portion including the corrugated pipe part 23), and the corrugated pipe part 23 is connected to the inlet 11 of the connecting tank.

In the present disclosure, the corrugated pipe part 23 is formed to have the minimum length allowing the filler pipe 21 to be assembled with the inlet 11 of the fuel tank 10. A blow molding method is used to manufacture the filler pipe 21 to be integrated with (i.e., to include) the corrugated pipe part 23.

A part of the filler pipe 21 of the filler neck 20, according to an embodiment of the present disclosure, has a predetermined inner diameter and outer diameter, i.e., a remaining part excluding the corrugated pipe part 23, and is referred to as a “main pipe part 22”.

When the filler pipe 21 is manufactured using the blow molding method, it is possible to form the corrugated pipe part 23 of the filler pipe 21 to the desired minimum length. Particularly, it is possible to increase the thickness of the corrugated pipe part 23.

Rigidity of the corrugated pipe part 23 is lower than that of the main pipe part 22, and the corrugated pipe part 23 has a shape and a structure in which foreign substances are easily accumulated in a valley portion between peak portions on the outer surface of the corrugated pipe part 23. Accordingly, it is desirable to provide the corrugated pipe part 23 having the minimum length allowing the filler pipe 21 to be assembled with the fuel tank 10.

In the present disclosure, as described above, the filler pipe 21 is manufactured through the blow molding method. In this manner, the thickness d1 of the main pipe part 22 and the thickness d2 of the corrugated pipe part 23 may be increased as compared with those manufactured through a conventional extrusion molding method.

FIG. 8 is a cross-sectional perspective view taken along the line “A-A” of FIG. 7. As shown in the drawing, the cross-sectional shape of the corrugated pipe part 23 may be an elliptical shape having a major axis and a minor axis instead of a circular shape.

In general, when a corrugated pipe is formed to have a circular shape, the radius, which is a distance from the center of the circle to the corrugated pipe, has a constant value. However, when a corrugated pipe is formed to have an elliptical shape having a major axis and a minor axis, the length of the major axis and the length of the minor axis may have different values.

In addition, in an embodiment of the present disclosure, a distance from the center of the cross section of the corrugated pipe part 23 to the inner surface of the corrugated pipe part 23 may vary depending on the circumferential location of the cross section of the corrugated pipe part 23, and a thickness of the corrugated pipe part 23 may also vary depending on the circumferential location of the cross section of the corrugated pipe part 23.

As described above, the corrugated pipe part 23 has a shape in which the peak portions and the valley portions which are gaps between two adjacent peak portions are repeatedly formed, and the valley portions of the corrugated pipe part 23 have a structure in which foreign substances are easily accumulated due to the corrugated shape.

When chemical substances such as calcium chloride, which is widely used as a deicing agent, are accumulated and are deposited in the valley portions of the corrugated pipe part 23, durability of the corrugated pipe part 23 may significantly deteriorate due to chemical reaction between materials forming the corrugated pipe and the chemical substances.

Therefore, in the present disclosure, the corrugated pipe part 23 is formed to have a shape in which foreign substances are not easily accumulated in the outer surface of the corrugated pipe part 23.

In the following description, in order to clearly describe the present disclosure, as shown in FIG. 8, the axis in the left-and-right direction of the cross section of the corrugated pipe part 23 is defined as the “X” axis, and the axis in the upward-and-downward direction is defined as the “Y” axis.

In addition, a distance from the center position of the cross section of the corrugated pipe part 23 to the upper inner surface of the corrugated pipe part 23 is defined as “H1”, and a thickness of the upper portion of the cross section of the corrugated pipe part 23 is defined as “T1”.

A distance from the center position of the cross section of the corrugated pipe part 23 to the inner surface of each of the left and right portions of the corrugated pipe part 23 in the cross-section of the corrugated pipe part 23 is defined as “L1”, and a thickness of each of the left and right portions of the corrugated pipe part 23 is defined as “T2”.

In an embodiment of the present disclosure, since the filler pipe 21 of the filler neck 20 and the corrugated pipe part 23 are integrally formed and are manufactured through a blow molding process, the thickness of the upper portion of the cross section of the corrugated pipe part 23 (T1) may be the same as the thickness of the lower portion thereof. Similarly, the thickness of the left portion of the cross section of the corrugated pipe part 23 (T2) may be the same as the thickness of the right portion thereof.

In addition, a distance from the center position of the cross section of the corrugated pipe part 23 to the upper inner surface of the cross section of the corrugated pipe part 23 (H1) and a distance from the center position of the cross section of the corrugated pipe part 23 to the lower inner surface of the cross section of the corrugated pipe part 23 may be the same. Further, a distance from the center position of the cross section of the corrugated pipe part 23 to the left inner surface of the cross section of the corrugated pipe part 23 (L1) and a distance from the center position of the cross section of the corrugated pipe part 23 to the right inner surface of the cross section of the corrugated pipe part 23 may be the same.

In an embodiment of the present disclosure, the corrugated pipe part 23 may be formed to have, instead of a circular shape, an elliptical cross-sectional shape having a major axis and a minor axis. In this case, the cross-sectional shape of the corrugated pipe part 23 may be formed in such a manner that L1, which is a distance in the X-axis direction, is greater than H1, which is a distance in the Y-axis direction (“L1>H1”).

As described above, when the cross-sectional shape of the corrugated pipe part 23 is an ellipse, in the cross-sectional shape of the corrugated pipe part 23, the X-axis direction, which is the left-and-right direction, becomes the major axis direction of the ellipse, and the Y-axis direction, which is the upward-and-downward direction, becomes the minor axis direction of the ellipse.

Additionally, the cross-sectional shape of the corrugated pipe part 23 may be formed in such manner that T1, which is the thickness of the upper portion of the cross-sectional shape of the corrugated pipe part 23, is larger than T2, which is the thickness of each of the left portion and the right portion of the cross-sectional shape of the corrugated pipe part 23.

In an embodiment of the present disclosure, foreign substances are mainly accumulated in the upper portion of the corrugated pipe part 23 in the filler pipe 21 of the filler neck 20 to which the corrugated pipe part 23 is applied. More specifically, foreign substances are mainly accumulated in a valley portion which is a gap between peak portions in the upper portion of the corrugated pipe part 23.

Therefore, durability of the upper portion of the cross section of the corrugated pipe part 23 may significantly deteriorate as compared with durability of other portions. Therefore, the thickness of the upper portion of the cross section of the corrugated pipe part 23 is formed to be larger than the thickness of each of the left and right portions of the cross section of the corrugated pipe part 23.

For this reason, in the present disclosure, the thickness T1 of the upper portion of the cross section of the corrugated pipe part 23 is formed to be larger than the thickness T2 of each of the left and right portions of the cross section of the corrugated pipe part 23 (T1>T2). In this manner, it is possible to have an effect of increasing the durability of the corrugated pipe part 23 by making the thickness T1 of the upper portion larger than the thickness T2 of each of the left and right portions.

In consideration of foreign substances being mainly accumulated in the upper portion of the cross section of the corrugated pipe part 23, the thickness of the upper portion of the cross section of the corrugated pipe part 23 is increased, thereby making it possible not only to improve durability of the corrugated pipe part 23, but also to achieve reliable quality of the entire filler neck 20 including the filler pipe 21.

In addition, when connecting the corrugated pipe part 23 of the filler pipe 21 to the inlet 11 of the fuel tank 10, a worker who performs this connection work may need to deform the left and right portions of the corrugated pipe part 23. In this case, the thickness of each of the left and right portions of the cross section of the corrugated pipe part 23 may be made smaller than the thickness of each of the upper and lower portions of the cross section of the corrugated pipe part 23, thereby making it easier to connect the corrugated pipe part 23 to the fuel tank 10 (improvement in assembly performance).

In other words, as described above, the thickness of the upper portion of the cross section of the corrugated pipe part 23 may be formed to be larger than the thickness of each of the left and right portions, and a worker may move the filler pipe 21 left and right in the corrugated pipe part 23 of the filler neck 20 so as to align the center of the inlet 11 of the fuel tank 10 with the center of the filler pipe 21, thereby accurately coupling the corrugated pipe part 23 to the fuel tank 10. In this manner, it is possible to improve assembly efficiency.

The filler pipe 21 of the filler neck 20 according to the present disclosure may be manufactured through a 3D suction blow molding process.

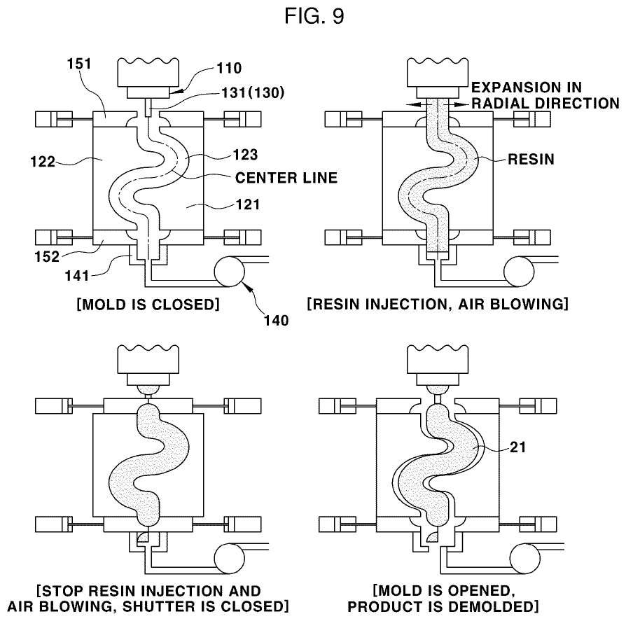

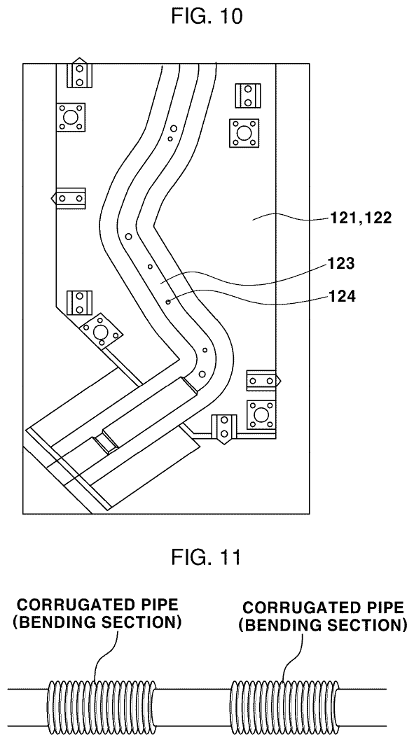

FIG. 9 is a view showing a process of molding the filler pipe integrated with the corrugated pipe in the filler neck according to an embodiment of the present disclosure. FIG. 10 is a view showing a mold for blow molding of the filler pipe integrated with the corrugated pipe in the filler neck according to an embodiment of the present disclosure.

In addition, FIG. 11 is a view of a comparative example to describe a problem in extrusion molding, showing a straight filler pipe 21 manufactured through extrusion molding. Prior to description as to the blow molding process, a problem when a filler pipe is manufactured by an extrusion molding method is described with reference to FIG. 11.

When the filler pipe integrated with the corrugated pipe part is manufactured using the extrusion molding method, bending may not be applied to the filler pipe during extrusion molding, and only a straight filler pipe may be manufactured using the extrusion molding method.

Therefore, it is necessary to separately perform the extrusion molding process and the bending process, and the bending process may be additionally applied to the filler pipe obtained by extrusion molding. However, the bending process may not be performed on a section of the filler pipe obtained by extrusion molding, where the inner and outer diameters of the filler pipe are constant. In other words, in the case of a filler pipe section having a constant inner diameter and outer diameter, the section has sufficient thickness and high rigidity for durability of the filler pipe. Accordingly, even when heat is applied to the section, bending may not be performed.

Therefore, when the extrusion molding method is used, first, extrusion is performed to form a straight corrugated pipe part in each section of the filler pipe where bending is required, and the filler pipe which is entirely straight and has straight corrugated pipe parts formed in several locations of the filler pipe is molded. Thereafter, the bending process is performed on each of the corrugated pipe parts to form a desired shape with a desired angle in a state in which the filler pipe is heated in an oven.

The bending process is only possible at the corrugated pipe part of the filler pipe. In the entire longitudinal section of a vehicle filler pipe, when bending is required not only at an end portion connected to a fuel tank, but also at multiple locations of the filler pipe depending on the vehicle specifications and installation conditions, as shown in FIG. 11, corrugated pipe parts need to be applied to all sections where bending is required.

However, when multiple corrugated pipe parts are formed in the entire section of the filler pipe for the bending process, in consideration of quality of the filler pipe, the corrugated pipe parts become vulnerable areas, which may cause deterioration in durability, and rigidity of the filler pipe may deteriorate due to the multiple corrugated pipe parts.

Accordingly, the present disclosure uses blow molding to manufacture the filler pipe, thereby solving the above-mentioned problems and increasing the overall thickness of the filler pipe as compared with extrusion molding.

When extrusion molding is used, heating and bending need to be performed on the corrugated pipe parts after molding of the filler pipe, so the thickness of each of the corrugated pipe parts is necessarily formed to be small in consideration of the bending process. However, when 3D suction blow molding is used, the filler pipe 21 may be molded into a bent shape and, as such, the bending process is not necessary after molding of the filler pipe 21. Accordingly, the thickness of each of the corrugated pipe parts 23 may be formed to be large.

In the case of blow molding, the bending process is not necessary after molding of the filler pipe 21, and the corrugated pipe part 23 only needs to be flexible for connection between the filler pipe 21 and the fuel tank 10. Accordingly, it is possible to increase the thickness of not only the main pipe part 22 but also the corrugated pipe part 23. In this manner, rigidity and durability of the filler pipe 21 may be increased.

In addition, since the filler pipe 21 having the bent shape may be molded through the molding process alone, in order to improve assembly performance, it is possible to apply the corrugated pipe part 23 only to a section of the filler pipe 21, which needs to be flexible, i.e., the end of the filler pipe 21 connected to the fuel tank 10.

In the case of blow molding, since the additional bending process is unnecessary after formation of the filler pipe 21, the corrugated pipe part 23 may be formed only in the minimum section of the end of the filler pipe 21, which is necessary for connection between the fuel tank 10 and the filler pipe 21. As a result, the number of vulnerable points in terms of quality is reduced, thereby increasing rigidity and durability of the filler pipe 21.

In addition, when the blow molding process is used, it is possible to mold and manufacture a filler pipe 21 having a smaller thickness deviation and a uniform thickness as compared with the extrusion molding process.

In an embodiment of the present disclosure, the main pipe part 22 has a thickness of at least 2 mm, and the corrugated pipe part 23 has a minimum thickness of at least 1 mm.

FIG. 9 is a view showing a blow molding device capable of molding the filler pipe 21 integrated with the corrugated pipe part 23 according to an embodiment of the present disclosure. The blow molding device is configured to produce a molded product in the shape of a cylinder or a tube by supplying a molding material between a pair of molds 121 and 122 and blowing air into the molding material supplied into the molds 121 and 122 to form an internal space of a certain volume.

Specifically, the blow molding device includes a material supply device 110 configured to supply a molding material, the pair of molds 121 and 122 provided to form a cavity 123 serving as an internal molding space capable of molding the filler pipe 21 integrated with the corrugated pipe part 23 in a closed state and configured to mold the molding material supplied into the cavity 123 by the material supply device 110, and a blowing device 130 configured to blow air into the molding material supplied into the cavity 123 so as to expand the molding material, thereby obtaining the shape of the filler pipe 21.

In addition, the blow molding device may further include an opening/closing device (not shown) configured to open/close the molds 121 and 122, and a suction device 140 configured to suction the molding material inside the molds in a state in which the molds 121 and 122 are closed.

In the molds 121 and 122, the suction device 140 may be located on the opposite side of the material supply device 110. In other words, when the material supply device 110 supplies and injects the molding material into the molds 121 and 122 in a state of being connected to the upper portion of the molds 121 and 122, the suction device 140 may be disposed to suction the molding material inside the molds 121 and 122 in a state of being connected to the lower portion of the molds 121 and 122.

The blow molding device having this configuration may perform a 3D suction blow molding process. In this case, while the material supply device 110 injects the molding material into the cavity 123, the suction device 140 suctions the molding material injected into the cavity 123 from a position on the opposite side of a position from which the molding material is supplied. Therefore, the molding material may be suctioned so as to correspond to the shape of the cavity 123.

Finally, according to the blow molding device including the suction device 140, even if the cavity 123 of the molds 121 and 122 has a complex or fine shape, the molding material may be smoothly injected into the cavity 123, thereby making it possible to manufacture a molded product having a complex shape.

FIG. 10 is a view showing an example of a mold for 3D suction blow molding capable of molding the filler pipe 21 integrated with the corrugated pipe part 23. It can be seen that a molding space for molding of the corrugated pipe part 23 is provided at the lower portion of the cavity 123 in a state in which the molds 121 and 122 are closed.

In addition, referring to FIG. 10, it can be seen that a plurality of suction holes 124 is formed along the inner surface of a portion where the cavity 123 is formed in the state in which the molds 121 and 122 are closed. Each of the suction holes 124 may be connected to an external separate suction device (not shown) through an internal passage penetrating the molds 121 and 122.

Since the suction holes 124 are formed as described above, the molding material may easily adhere to the inner surface of the cavity 123 during the molding process. Accordingly, it is possible to easily mold a product having a complex shape while a product to be molded is uniformly formed to a desired thickness.

Referring back to FIG. 9, the molding process of the filler pipe 21 integrated with the corrugated pipe part 23 is described in more detail. A cap 141 is connected to the lower portion of the molds 121 and 122 in a state in which the molds 121 and 122 are closed by the opening/closing device (not shown). Subsequently, the material supply device 110 is operated to inject the molding material into the cavity 123 through the upper portion of the molds 121 and 122.

A molding material (molten resin) injected into the cavity 123 flows downwards along the cavity of the molds 121 and 122. The suction device 140 is operated to suction the molding material injected into the cavity 123 of the molds 121 and 122 from the opposite side of the material supply device 110.

In addition, after the molding material is moved along the cavity 123, air is blown into the molding material. In this case, the blowing device 130 is operated to supply air through the upper portion of the molds 121 and 122, which is a material injection location, using a blow pin 131.

In this manner, when air is blown into the inside of the molding material injected into the cavity 123, the molding material may expand so as to be formed into the pipe shape (i.e., a hollow cylindrical shape). Suction force is applied into the cavity 123 through the suction holes 124 so as to cause the expanded molding material to adhere to the inner surface of the cavity 123. As a result, the desired filler pipe 21 may be formed through the shape of the cavity 123.

Then, the operation of the material supply device 110 and the operation of the blowing device 130 are stopped so as to stop supply of the molding material and blowing of air. Further, since the operation of the suction device 140 is stopped, suction for the molding material is also stopped.

In addition, the product is cured in a state in which shutters 151 and 152 respectively installed at the upper and lower portions of the molds 121 and 122 are closed. After molding is completed, the shutters 151 and 152 are opened, and the molds 121 and 122 are opened by the opening/closing device. Then, the molded product, i.e., the filler pipe 21 integrated with the corrugated pipe part 23, is demolded from the molds 121 and 122.

As described above, in the present disclosure, the corrugated pipe part 23 is formed to have an elliptical cross-sectional shape and has different thicknesses depending on the circumferential locations of the cross section thereof. Further, the corrugated pipe part 23 is formed to be integrated with the end of the filler pipe 21. The overall shape of the filler pipe 21 has a bent shape at a predetermined section.

To form the filler pipe 21, the cavity 123 in the molds 121 and 122 has a shape including a bent section identical to the desired shape of the filler pipe 21. Further, in the section for molding of the corrugated pipe part 23 in the cavity 123, the cross-sectional shape of the cavity 123 is designed and set in consideration of the cross-sectional shape of the filler pipe 21.

In other words, in the section for molding of the corrugated pipe part 23, a distance in the X-axis direction from the cross-sectional center position of the cavity 123 to the inner surface of the cavity 123 is different from a distance in the Y-axis direction from the cross-sectional center position of the cavity 123 to the inner surface of the cavity 123. Accordingly, the filler pipe 21 having a cross-sectional shape of “H1<L1” may be molded.

When the molding material (resin) injected into the molds 121 and 122 during blow molding flows downwards along the cavity 123 and then air is blown into the molding material through the blow pin 131, the molding material expands radially toward the inner surface of the cavity 123. The cross-sectional shape of the cavity 123 is designed and set such that “H1<L1” is achieved in the corrugated pipe part 23 of the filler pipe 21 and in the molding section for the corrugated pipe part 23 of the cavity 123. Accordingly, the molding material expanding radially within the cavity 123 is concentrated more on the upper portion of the corrugated pipe part 23 in the Y-axis direction. The upper portion in the Y-axis direction of the corrugated pipe part 23 is located closer to the center position of the cross section of the corrugated pipe part 23 than the left and right portions in the X-axis direction of the corrugated pipe part 23. In other words, the thickness T1 of the upper portion of the corrugated pipe part 23 to be molded becomes larger than the thickness T2 of each of the left and right portions of the corrugated pipe part 23.

The molding material expanding radially within the cavity 123 is less concentrated on the left and right portions in the X-axis direction of the corrugated pipe part 23. The left and right portions in the X-axis direction of the corrugated pipe part 23 are located farther from the center position of the cross section of the corrugated pipe part 23 than the upper portion in the Y-axis direction of the corrugated pipe part 23. Accordingly, the thickness T2 of each of the left and right portions of the molded corrugated pipe part 23 becomes smaller than the thickness T1.

The vehicle filler neck according to an embodiment of the present disclosure has been described in detail, and the filler neck 20 includes the filler pipe 21 connected to the fuel tank 10. The filler pipe 21 has the corrugated pipe part 23 located at the end thereof connected to the fuel tank 10. In this way, the corrugated pipe part 23 is formed to be integrated with the filler pipe 21.

In addition, in the present disclosure, the filler pipe 21 having the corrugated pipe part 23 integrally formed at the end thereof is molded and manufactured using the blow molding method as described above. In the shape of the corrugated pipe part 23, a distance from the center position of the cross section of the corrugated pipe part 23 to the inner surface of the corrugated pipe part 23 varies depending on the circumferential location of the cross section of the corrugated pipe part 23, and a thickness of the corrugated pipe part 23 also varies depending on the circumferential location of the cross section of the corrugated pipe part 23.

Additionally, when the filler pipe 21 is molded using the blow molding method as described above, the filler pipe 21 may be formed using a resin composition containing PA6, PAMXD6, a copolymer of ethylene and octane, an ethylene-octene copolymer (EOC), and nanoclay as a raw material.

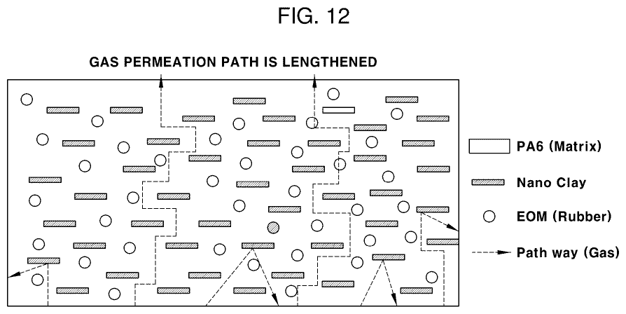

FIG. 12 is a view showing the principle that gas is blocked in the filler pipe 21 of the filler neck 20 according to an embodiment of the present disclosure. Nanoclay in the resin composition is an ingredient that enhances gas barrier properties. In the filler pipe 21 formed of the resin composition, a gas permeation path is lengthened by nanoclay in a state in which nanoclay and EOM rubber are mixed with PA6 serving as a base material, thereby obtaining a gas blocking effect.

As is apparent from the above description, according to a filler neck integrated with a corrugated pipe and a method of manufacturing the same, since a conventional filler hose is not used, assembly performance and durability of the filler neck may be improved as compared with a case in which the filler hose is used.

Furthermore, since coupling members configured to respectively couple both ends of a conventional filler hose to other components are removed, it is possible to reduce manufacturing costs, the number of components, and the number of assembly procedures. Furthermore, it is possible to solve a problem related to evaporation gas penetrating the filler hose.

The present disclosure has been described in detail with reference to embodiments thereof. However, it should be appreciated by those having ordinary skill in the art that changes may be made in these embodiments without departing from the principles and spirit of the disclosure, the scope of which is defined in the appended claims and equivalents thereto.

What is claimed is:

1. A filler neck integrated with a corrugated pipe part, the filler neck comprising a filler pipe configured to be connected to a fuel tank, wherein:
the filler pipe has an end portion including the corrugated pipe part, the end portion being configured to be connected to the fuel tank; and
in a cross-sectional shape of the corrugated pipe part, a thickness of an upper portion of the corrugated pipe part in a cross section is larger than a thickness of each of a left portion and a right portion of the corrugated pipe part in the cross section.

2. The filler neck of claim 1, wherein the cross-sectional shape of the corrugated pipe part is an ellipse having a minor axis in a first direction of the corrugated pipe part and a major axis in a second direction of the corrugated pipe part.

3. The filler neck of claim 2, wherein the first direction is an upward and downward direction of the corrugated pipe part and the second direction is a left and right direction of the corrugated pipe part.

4. The filler neck of claim 2, wherein a diameter of the ellipse along the major axis is greater than a diameter of the ellipse along the minor axis.

5. The filler neck of claim 1, wherein, in the cross-sectional shape of the corrugated pipe part, a distance from a central portion of the corrugated pipe part to the upper portion of the corrugated pipe part is smaller than a distance from the central portion of the corrugated pipe part to each of the left portion and the right portion of the corrugated pipe part.

6. The filler neck of claim 1, wherein the filler pipe having the end portion including the corrugated pipe part is molded by a suction blow molding process of injecting a molding material into a cavity through a first side of a closed mold, suctioning the molding material injected into the cavity through a second side of the closed mold, allowing the molding material to move along the cavity, and blowing air into the molding material moving along the cavity, causing the molding material expanded by the air to adhere to an inner surface of the cavity and molding a pipe shape.

7. A method of manufacturing a filler neck integrated with a corrugated pipe part, the method comprising molding a filler pipe having an end portion including the corrugated pipe part,
wherein the end portion is configured to be connected to a fuel tank, and
wherein in a cross-sectional shape of the corrugated pipe part, a thickness of an upper portion of the corrugated pipe part in a cross section is larger than a thickness of each of a left portion and a right portion of the corrugated pipe part in the cross section.

8. The method of claim 7, wherein the cross-sectional shape of the corrugated pipe part is an ellipse having a minor axis in a first direction of the corrugated pipe part and a major axis in a second direction of the corrugated pipe part.

9. The method of claim 8, wherein the first direction is an upward and downward direction of the corrugated pipe part and the second direction is a left and right direction of the corrugated pipe part.

10. The method of claim 8, wherein a diameter of the ellipse along the major axis is greater than a diameter of the ellipse along the minor axis.

11. The method of claim 7, wherein the cross-sectional shape of the corrugated pipe part is formed such that a distance from a central portion of the corrugated pipe part to the upper portion of the corrugated pipe part is smaller than a distance from the central portion of the corrugated pipe part to each of the left and right portions of the corrugated pipe part.

12. The method of claim 7, wherein the molding of the filler pipe having the end portion including the corrugated pipe part includes a suction blow molding process to mold a pipe shape, the molding process comprising:
injecting a molding material into a cavity of a closed mold through a first side of the closed mold:
suctioning the molding material injected into the cavity through a second side of the closed mold:
allowing the molding material to move along the cavity; and
blowing air into the molding material moving along the cavity, such that the molding material is expanded by the air and adheres to an inner surface of the cavity to form the pipe shape.

13. The method of claim 12, wherein the cavity of the closed mold has an end portion including a molding space, the molding space being configured to mold the corrugated pipe part of the filler pipe.

14. The method of claim 7, wherein the filler pipe is manufactured using a resin composition containing polyamide PA6, PAMXD6, ethylene-octene copolymer (EOC), and nanoclay.

15. A filler pipe of a filler neck, the filler pipe comprising:
a main pipe part; and
a corrugated pipe part having a first end and a second end, wherein the first end of the corrugated pipe part is integrally formed with the main pipe part.

16. The filler pipe of claim 15, further comprising a quick connector coupled to the second end of the corrugated pipe part.

17. The filler pipe of claim 15, wherein a cross-sectional shape of the corrugated pipe part is an ellipse having a minor axis in a first direction of the corrugated pipe part and a major axis in a second direction of the corrugated pipe part.

18. The filler pipe of claim 17, wherein a thickness of the corrugated pipe part along the minor axis is larger than a thickness of the corrugated pipe part along the major axis.

19. The filler pipe of claim 15, wherein a rigidity of the corrugated pipe part is lower than a rigidity of the main pipe part.
